(19) United States
(12) Patent Application Publication
(10) Pub. No.: US 2022/0275161 A1
(43) Pub. Date: Sep. 1, 2022

(54) ISOCYANATE-BASED FOAM AND PROCESS FOR PRODUCTION THEREOF

(71) Applicant: Proprietect L.P., Toronto (CA)

(72) Inventors: Wenwei Zhao, Oakville (CA); Eugen Smeianu, Thornhill (CA); Min Xie, Mississauga (CA); Gerry Lee, Toronto (CA)

(21) Appl. No.: 17/634,445

(22) PCT Filed: Aug. 27, 2020
(86) PCT No.: PCT/CA2020/051165

§ 371 Date: Feb. 10, 2022

Related U.S. Application Data
(60) Provisional application No. 62/922,801, filed on Aug. 30, 2019.

(51) Int. Cl. C08J 9/12; C08G 18/48; C08G 18/38

(52) U.S. Cl. CPC C08J 9/125; C08G 18/4804; C08G 18/3885; C08G 18/3804; C08G 2110/0083; C08G 2110/005; C08J 2375/08

(57) ABSTRACT

There is described an isocyanate-based polymer foam having the combination of: (i) a Limiting Oxygen Index (LOI) of greater than or equal to 26.5% when measured pursuant to ASTM D2863-17a, and (ii) a Total Volatile Organic Content (TVOC) when measured pursuant to VDA 277 of less than or equal to 225 μg/g C. Preferably, the foam is produced from a foamable composition comprising: an isocyanate; a reactive compound containing: (1) at least one hydrogen which is reactive with the isocyanate, and (2) one or both of a halogen and a phosphate moiety; a blowing agent comprising one or both of water and carbon dioxide; and a catalyst; wherein the reactive compound is present in an amount in the range of from about 30% to about 95% of total ISO equivalents excluding water, if present in the foamable composition.

### CROSS-REFERENCE TO RELATED APPLICATION

The present application claims the benefit under 35 U.S.C. § 119(e) of provisional patent application Ser. No. 62/922,801, filed Aug. 30, 2019, the contents of which are hereby incorporated by reference.

### BACKGROUND OF THE INVENTION

### Field of the Invention

In one of its aspects, the present invention relates to an isocyanate-based foam. In another of its aspects, the present invention relates to a process for producing an isocyanate-based foam. In yet another of its aspects, the present invention relates to an isocyanate-based foam have improved flammability properties. In yet another of its aspects, the present invention relates to a sprayable isocyanate-based foam have improved flammability properties.

### Description of the Prior Art

Isocyanate-based polymers are known in the art. Generally, those of skill in the art understand isocyanate-based polymers to be polyurethanes, polyureas, polyisocyanurates and mixtures thereof.

It is also known in the art to produce foamed isocyanate-based polymers. Indeed, one of the advantages of isocyanate-based polymers compared to other polymer systems is that polymerization and foaming can occur in situ. This results in the ability to mold the polymer while it is forming and expanding.

One of the conventional ways to produce a polyurethane foam is known as the “one-shot” technique. In this technique, the isocyanate, a suitable polyol, a catalyst, water (which acts as a reactive “blowing” agent and can optionally be supplemented with one or more physical blowing agents) and other additives are mixed together at once using, for example, impingement mixing (e.g., high pressure). Generally, if one were to produce a polyurea, the polyol would be replaced with a suitable polyamine. A polyisocyanurate may result from cyclotrimerization of the isocyanate component. Urethane modified polyureas or polyisocyanurates are known in the art. In either scenario, the reactants would be intimately mixed very quickly using a suitable mixing technique.

Low density, spray polyurethane foam (SPF) is a semi-rigid material with a sponge-like appearance that expands during installation and creates small, open cells that are filled with carbon dioxide. Due to its ability to expand during the application process, it fills cracks, crevices and voids and adheres to irregular surfaces or substrates to form an air sealing insulation material.

When installed or applied, SPF will act as an air barrier and as a sound absorber by blocking and absorbing air leakage. It is an insulating material having widespread applications. One known application is spraying onto interior walls of mass transportation vehicles such as buses, trains and the like.

Spray polyurethane foam has by far the highest R-value of any insulation product. The R-value is simply the insulating power of a product. Independent laboratories have conducted various studies on the R-value of spray polyurethane foam in relation to other types such as fiberglass and cellulose, and the results are heavily in favour of spray polyurethane foam which typically has an R-value of 6-7.

Despite the advances made to date, there is room for improvement. Specifically, known SPF is highly flammable and/or has high levels of volatile organic carbon compounds. These problems are particularly acute when SPF is applied to interior walls of mass transportation vehicles such as buses, trains and the like.

There is an ongoing need for a spray foam (polyurethane or otherwise) that has a combination of lower flammability and lower levels of volatile organic compounds.

### SUMMARY OF THE INVENTION

It is an object of the present invention to obviate or mitigate at least one of the above-mentioned disadvantages of the prior art.

It is another object of the present invention to provide a novel isocyanate-based polymer foam.

It is yet another object of the present invention to provide a novel process for producing an isocyanate-based polymer foam.

Accordingly, in one of its aspects, the present invention provides an isocyanate-based polymer foam having the combination of: (i) a Limiting Oxygen Index (LOI) of greater than or equal to 26.5% when measured pursuant to ASTM D2863-17a, and (ii) a Total Volatile Organic Content (TVOC) when measured pursuant to VDA 277 of less than or equal to 225 μg/g C.

In another of its aspects, the present invention provides an isocyanate-based polymer foam produced from a foamable composition comprising:

(a) an isocyanate;

(b) a reactive compound containing: (1) at least one hydrogen which is reactive with the isocyanate, and (2) one or both of a halogen and a phosphate moiety;

(c) a blowing agent comprising one or both water and carbon dioxide; and

(d) a catalyst;

wherein the reactive compound is present in an amount in the range of from about 30% to about 95% of total ISO equivalents excluding water, if present in the foamable composition.

As used through this specification, the term ISO equivalents is a percentage and may be determined as follows:

% equivalents of a given compound=(equivalents of a given compound)/sum (the equivalents of all compounds excluding water in the resin formulation)*100

wherein:

isocyanate equivalents of a compound=(weight of the compound in resin formulation)/the equivalent weight of the compound

Thus, the present inventors have discovered a novel approach to the production of sprayable foam composition that represents a significant improvement to commercially known SPF's. Specifically, the present inventors have discovered that conventional polyols (described in more detail below) may be omitted from the foamable composition and replaced (or substantially completely replaced) with a particular type of reactive compound resulting in an isocyanate-based polymer foam that has a highly desirable combination of LOI and TVOC without any significant deterioration of other physical properties. The reactive compound itself may be regarded as a flame retardant and contains: (1) at least one hydrogen which is reactive with the isocyanate, and (2) one or both of a halogen and a phosphate moiety. This definition for reactive compound excludes conventional polyols used to produce polyurethane foam. Thus, strictly speaking, the present isocyanate-based polymer foam may not be regarded as a polyurethane foam (i.e., a polymer foam made from isocyanate and conventional polyol as the major reactants). The present inventors further discovered that LOI or TVOC could be improved in a limited way by adjusting known certain ingredients in known SPF formulations but that it was not possible to significantly improve both of the LOI and TVOC unless the conventional polyols were replaced (or substantially completely replaced) with the reactive compound described herein.

### DETAILED DESCRIPTION OF THE PREFERRED EMBODIMENTS

In one of its aspects, the present invention relates to an isocyanate-based polymer foam having the combination of: (i) a Limiting Oxygen Index (LOI) of greater than or equal to 26.5% when measured pursuant to ASTM D2863-17a, and (ii) a Total Volatile Organic Content (TVOC) when measured pursuant to VDA 277 of less than or equal to 225 μg/g C.

Preferred embodiments of this embodiment of the present invention may include any one or a combination of any two or more any of the following features:
the isocyanate-based polymer foam has a LOI in the range of from 26.5% to 35.0%;
the isocyanate-based polymer foam has a LOI in the range of from 27.0% to 35.0%;
the isocyanate-based polymer foam has a LOI in the range of from 27.0% to 34.0%;
the isocyanate-based polymer foam has a LOI in the range of from 27.0% to 33.0%;
the isocyanate-based polymer foam has a LOI in the range of from 27.0% to 32.0%;
the isocyanate-based polymer foam has a LOI in the range of from 27.0% to 31.0%;
the isocyanate-based polymer foam has a LOI in the range of from 27.5% to 31.0%;
the isocyanate-based polymer foam has a LOI in the range of from 27.0% to 30.0%;
the isocyanate-based polymer foam has a LOI in the range of from 27.5% to 30.0%;
the isocyanate-based polymer foam has a LOI in the range of from 28.0% to 30.0%;
the isocyanate-based polymer foam has a TVOC in the range of from 50 to 225 μg/g C;
the isocyanate-based polymer foam has a TVOC in the range of from 50 to 215 μg/g C;
the isocyanate-based polymer foam has a TVOC in the range of from 50 to 180 μg/g C;
the isocyanate-based polymer foam has a TVOC in the range of from 50 to 170 μg/g C;
the isocyanate-based polymer foam has a TVOC in the range of from 50 to 150 μg/g C;
the isocyanate-based polymer foam has a TVOC in the range of from 60 to 150 μg/g C;
the isocyanate-based polymer foam has a TVOC in the range of from 70 to 150 μg/g C;
the isocyanate-based polymer foam has a TVOC in the range of from 70 to 140 μg/g C;
the isocyanate-based polymer foam has a TVOC in the range of from 70 to 130 μg/g C;
the isocyanate-based polymer foam has a TVOC in the range of from 70 to 120 μg/g C;
the isocyanate-based polymer foam has a TVOC in the range of from 70 to 110 μg/g C;
the isocyanate-based polymer foam has a TVOC in the range of from 70 to 100 μg/g C;
the isocyanate-based polymer foam has a density in the range of from about 8.0 to about 48 kg/m³;
the isocyanate-based polymer foam has a density in the range of from about 16 to about 40 kg/m³;
the isocyanate-based polymer foam has a density in the range of from about 24 to about 32 kg/m³; and/or the isocyanate-based polymer foam is produced from a foamable composition comprising:
   (a) an isocyanate;
   (b) a reactive compound containing: (1) at least one hydrogen which is reactive with the isocyanate, and (2) one or both of a halogen and a phosphate moiety;
   (c) a blowing agent comprising one or both of water and carbon dioxide; and
   (d) a catalyst;
   wherein the reactive compound is present in an amount in the range of from about 30% to about 95% of total ISO equivalents excluding water, if present in the foamable composition.

In another of its aspects, the present invention relates to an isocyanate-based polymer foam produced from a foamable composition comprising:
(a) an isocyanate;
(b) a reactive compound containing: (1) at least one hydrogen which is reactive with the isocyanate, and (2) one or both of a halogen and a phosphate moiety;
(c) a blowing agent comprising one or both of water and carbon dioxide; and
(d) a catalyst;

wherein the reactive compound is present in an amount in the range of from about 30% to about 95% of total ISO equivalents excluding water, if present in the foamable composition.

Preferred embodiments of the foamable composition relating to all aspects of the present invention may include any one or a combination of any two or more any of the following features:
the reactive compound is present in an amount in the range of from about 40% to about 90% of total ISO equivalents excluding water;
the reactive compound is present in an amount in the range of from about 45% to about 85% of total ISO equivalents excluding water;
the reactive compound contains one or more of the following moieties: hydroxyl (R—OH), amino (R—NH2) and iminyl (R═NH);
the reactive compound is selected from the group consisting of halogenated aromatic esters, halogenated aromatic ethers, halogenated aliphatic esters, halogenated aliphatic ethers, halogenated phosphate ester, non-halogenated phosphate esters and mixtures thereof;
the foamable composition is substantially completely free of a polyol comprising a hydroxyl-terminated backbone of a member selected from the group consisting of polyether, polyester, polycarbonate, polydiene and polycaprolactone;
the isocyanate comprises a prepolymer;
the isocyanate is selected from the group consisting of 1,6-hexamethylene diisocyanate, 1,4-butylene diisocyanate, furfurylidene diisocyanate, 2,4-toluene diisocyanate, 2,6-toluene diisocyanate, 2,4′-diphenylmethane diisocyanate, 4,4′-diphenylmethane diisocyanate, 4,4′-diphenylpropane diisocyanate, 4,4′-diphenyl-3,3′-dimethyl methane diisocyanate, 1,5-naphthalene diisocyanate, 1-methyl-2,4-diisocyanate-5-chlorobenzene, 2,4-diisocyanato-s-triazine, 1-methyl-2,4-diisocyanato cyclohexane, p-phenylene diisocyanate, m-phenylene diisocyanate, 1,4-naphthalene diisocyanate, dianisidine diisocyanate, bitolylene diisocyanate, 1,4-xylylene diisocyanate, 1,3-xylylene diisocyanate, bis-(4-isocyanatophenyl)methane, bis-(3-methyl-4-isocyanatophenyl)methane, polymethylene polyphenyl polyisocyanates and mixtures thereof.
the isocyanate is selected from the group consisting essentially of (i) 2,4′-diphenylmethane diisocyanate, 4,4′-diphenylmethane diisocyanate and mixtures thereof; and (ii) mixtures of (i) with an isocyanate selected from the group consisting of 2,4-toluene diisocyanate, 2,6-toluene diisocyanate and mixtures thereof;
the isocyanate-based polymer foam defined in any one of claims 24-30, wherein the isocyanate is selected from the group consisting essentially of 2,4′-diphenylmethane diisocyanate, 4,4′-diphenylmethane diisocyanate and mixtures thereof;
the isocyanate is present in an amount to provide an isocyanate index in the range of from about 60 to about 200;
the isocyanate is present in an amount to provide an isocyanate index in the range of from about 80 to about 160;
the isocyanate is present in an amount to provide an isocyanate index in the range of from about 100 to about 150;
water is present in the foamable composition as the sole blowing agent;
the water is present in an amount in the range of from about 3.0 to about 15 percent by weight of the foamable composition excluding the isocyanate;
the water is present in an amount in the range of from about 4.0 to about 8.0 percent by weight of the foamable composition excluding the isocyanate; and/or
the water is present in an amount in the range of from about 4.0 to about 6.0 percent by weight of the foamable composition excluding the isocyanate.

### Isocyanates

The isocyanate suitable for use in the reaction mixture is not particularly restricted and the choice thereof is within the purview of a person skilled in the art. Generally, the isocyanate compound suitable for use may be represented by the general formula:

Q(NCO)ᵢ

wherein i is an integer of two or more and Q is an organic radical having the valence of i. Q may be a substituted or unsubstituted hydrocarbon group (e.g., an alkylene or arylene group). Moreover, Q may be represented by the general formula:

Q¹-Z-Q¹

wherein Q¹ is an alkylene or arylene group and Z is chosen from the group comprising —O—, —O-Q¹-, —CO—, —S—, —S-Q¹-S—, —SO₂— and -Q-N═C═N-Q-. Examples of isocyanate compounds which fall within the scope of this definition include hexamethylenediisocyanate, 1,8-diisocyanato-p-methane, xylyldiisocyanate, (OCNCH₂CH₂CH₂OCH₂O)₂, 1-methyl-2,4-diisocyanatocyclohexane, phenylenediisocyanates, tolylenediisocyanates, chlorophenylenediisocyanates, diphenylmethane-4,4′-diisocyanate, naphthalene-1,5-diisocyanate, triphenyl-methane-4,4′,4″-triisocyanate and isopropylbenzene-alpha-4-diisocyanate.

In another embodiment, Q may also represent a polyurethane radical having a valence of i. In this case Q(NCO)ᵢ is a compound which is commonly referred to in the art as a prepolymer. Generally, a prepolymer may be prepared by reacting a stoichiometric excess of an isocyanate compound (as defined hereinabove) with an active hydrogen-containing compound (as defined hereinafter), preferably the polyhydroxyl-containing materials or polyols described below. In this embodiment, the polyisocyanate may be, for example, used in proportions of from about 30 percent to about 200 percent stoichiometric excess with respect to the proportion of active hydrogen in the reactive compound. Since the process of the present invention may relate to the production of polyurea foams, it will be appreciated that in this embodiment, the prepolymer could be used to prepare a polyurethane modified polyurea.

In another embodiment, the isocyanate compound suitable for use in the process of the present invention may be selected from dimers and trimers of isocyanates and diisocyanates, and from polymeric diisocyanates having the general formula:

Q′[(NCO)ᵢ]ⱼ

wherein both i and j are integers having a value of 2 or more, and Q′ is a polyfunctional organic radical, and/or, as additional components in the reaction mixture, compounds having the general formula:

L(NCO)ᵢ

wherein i is an integer having a value of 1 or more and L is a monofunctional or polyfunctional atom or radical. Examples of isocyanate compounds which fall with the scope of this definition include ethylphosphonicdiisocyanate, phenylphosphonicdiisocyanate, compounds which contain a=Si—NCO group, isocyanate compounds derived from sulphonamides (QSO₂NCO), cyanic acid and thiocyanic acid.

See also for example, British patent number 1,453,258, for a discussion of suitable isocyanates.

Non-limiting examples of suitable isocyanates include: 1,6-hexamethylene diisocyanate, 1,4-butylene diisocyanate, furfurylidenediisocyanate, 2,4-toluene diisocyanate, 2,6-toluene diisocyanate, 2,4′-diphenylmethane diisocyanate, 4,4′-diphenylmethane diisocyanate, 4,4′-diphenylpropane diisocyanate, 4,4′-diphenyl-3,3′-dimethyl methane diisocyanate, carbodiimide modified 4,4′-diphenylmethanediisocyanate, 1,5-naphthalene diisocyanate, 1-methyl-2,4-diisocyanate-5-chlorobenzene, 2,4-diisocyanato-s-triazine, 1-methyl-2,4-diisocyanato cyclohexane, p-phenylenediisocyanate, m-phenylenediisocyanate, 1,4-naphthalene diisocyanate, dianisidinediisocyanate, bitolylenediisocyanate, 1,4-xylylene diisocyanate, 1,3-xylylene diisocyanate, bis-(4-isocyanatophenyl)methane, bis-(3-methyl-4-isocyanatophenyl)methane, polymethylenepolyphenylpolyisocyanates and mixtures thereof. A more preferred isocyanate is selected from the group comprising 2,4′-diphenylmethane diisocyanate, 4,4′-diphenylmethane diisocyanate and mixtures thereof as well as polymeric MDI which is also known as crude MDI. Another more preferred isocyanate is selected from the group comprising 2,4-toluene diisocyanate, 2,6-toluene diisocyanate and mixtures thereof, for example, a mixture comprising from about 75 to about 85 percent by weight 2,4-toluene diisocyanate and from about 15 to about 25 percent by weight 2,6-toluene diisocyanate.

### Reactive Compound

Unlike in the production of conventional polyurethane foams, the main reactants in the foamable composition used to produce the present isocyanate-based polymer foam are: isocyanate and a reactive compound containing: (1) at least one hydrogen which is reactive with the isocyanate, and (2) one or both of a halogen and a phosphate moiety. It is preferred that the foamable composition not contain in conventional polyols (described below) used to produce polyurethane foam.

Preferably, the reactive compound is selected from the group consisting of halogenated aromatic esters, halogenated aromatic ethers, halogenated aliphatic esters, halogenated aliphatic ethers, halogenated phosphate ester, non-halogenated phosphate esters and mixtures thereof.

### Conventional Polyols

The following discussion is focused on so-called conventional polyols. While it is preferred that the foamable composition used to produce the present isocyanate-based polymer foams is free of conventional polyols, in some embodiments, such polyols may be present in relatively minor amounts.

By “minor amounts” is meant up to about 30% of total ISO equivalents excluding water in the foamable composition, more preferably up to about 20% of total ISO equivalents excluding water in the foamable composition, even more preferably up to about 10% of total ISO equivalents excluding water in the foamable composition, most preferably up to about 5% of total ISO equivalents excluding water in the foamable composition.

The reaction mixture used to produce the present polyurethane foam comprises a first polyol comprising a first polymer chain consisting essentially of propylene oxide units and alkylene oxide units selected from ethylene oxide, butylene oxide and mixtures thereof in a weight ratio of propylene oxide units to alkylene oxide units in the range of from about 90:10 to about 25:75, the polymer chain being terminally capped with the ethylene oxide units, the first polyol having a primary hydroxyl content of at least about 70% based on the total hydroxyl content of the first polyol. These features of the first polyol are typical for polyols normally used to produce molded foam.

The first polyol can be used alone or in combination with a second polyol comprising a second polymer chain consisting essentially of propylene oxide units and alkylene oxide units selected from ethylene oxide, butylene oxide and mixtures thereof in a weight ratio of propylene oxide units to alkylene oxide units in the range of from about 100:0 to about 60:40, the polymer chain being terminally capped with the alkylene oxide units, the second polyol having a secondary hydroxyl content of at least about 95% based on the total hydroxyl content of the second polyol. These features of the second polyol are typical for polyols normally used to produce slab (free rise) foam.

Within these definitions for the first polyol and the second polyol, the polyol may be a hydroxyl-terminated backbone of a member selected from the group comprising polyether, polyester, polycarbonate, polydiene and polycaprolactone. Preferably, the polyol is selected from the group comprising hydroxyl-terminated polyhydrocarbons, hydroxyl-terminated polyformals, fatty acid triglycerides, hydroxyl-terminated polyesters, hydroxymethyl-terminated polyesters, hydroxymethyl-terminated perfluoromethylenes, polyalkyleneether glycols, polyalkylenearyleneether glycols and polyalkyleneethertriols. More preferred polyols are selected from the group comprising adipic acid-ethylene glycol polyester, poly(butylene glycol), poly(propylene glycol) and hydroxyl-terminated polybutadiene—see, for example, British patent number 1,482,213, for a discussion of suitable polyols. Preferably, such a polyether polyol has a molecular weight in the range of from about 100 to about 10,000, more preferably from about 100 to about 4,000, most preferably from about 100 to about 3,500.

In another embodiment, the second polyol may comprise a polymer polyol, also known as graft copolymer polyols. As is known in the art, such polyols are generally polyether polyol dispersions which are filled with other organic polymers. Such polymer polyols are useful in load building or improving the hardness of the foam when compared to using unmodified polyols. Non-limiting examples of useful polymer polyols include: chain-growth copolymer polyols (e.g., containing particulate poly(acrylonitrile), poly(styrene-acrylonitrile) and mixtures thereof), and/or step-growth copolymer polyols (e.g., PolyHarnstoff Dispersions (PHD), polyisocyanatepolyaddition (PIPA) polyols, epoxy dispersion polyols and mixtures thereof). For further information on polymer polyols, see, for example, Chapter 2 of FLEXIBLE FOAM FUNDAMENTALS, Herrington et al. (1991) and the references cited therein. If a polymer polyol is used, it is preferred to mix the polymer polyol with a base polyol. Generally, mixtures may be used which contain polymer polyol in an amount in the range of from about 5 to about 50 percent by weight of unmodified polyol present in the mixture.

The second polyol may also be a so-called bio-based polyol. As used throughout this specification, the term “bio-based polyols” is a generic term intended to encompass polyols derived from renewable resources such as a vegetable oil or another bio-originated material.

The preferred bio-based polyol is a vegetable oil-based polyol. Non-limiting examples of suitable vegetable oils from which such a polyols may be derived include soybean oil, safflower oil, linseed oil, corn oil, sunflower oil, olive oil, canola oil, sesame oil, cottonseed oil, palm oil, rapeseed oil, tung oil, fish oil, peanut oil and combinations thereof. Also useful are partially hydrogenated vegetable oils and genetically modified vegetable oils, including high oleic safflower oil, high oleic soybean oil, high oleic peanut oil, high oleic sunflower oil and high erucic rapeseed oil (crambe oil).

A suitable method to prepare the bio-based (e.g., vegetable oil-based) polyol involves reacting the vegetable oil (or mixture of vegetable oils) with a peroxyacid, providing an epoxidized vegetable oil. Essentially, some or all of the double bonds of the vegetable oil may be epoxidized. The epoxidized vegetable oil may be further reacted with an alcohol, a catalytic amount of fluoroboric acid and, optionally, water to form the polyol. Such polyols contain all secondary hydroxyl groups.

These bio-based polyols may be used directly in a reaction mixture to produce an isocyanate-based foam such as a polyurethane foam. Alternatively, the bio-based polyols may be reacted with the epoxidized vegetable oils described above in the presence of a fluoroboric acid catalyst and, optionally, water to form a bio-based polyol suitable for use in a reaction mixture to produce an isocyanate-based foam such as a polyurethane foam.

Examples of such preparations are described, for example, in one or more of
U.S. Pat. No. 6,686,435 [Petrovic et al.];
U.S. Pat. No. 6,107,433 [Petrovic et al.];
U.S. Pat. No. 6,573,354 [Petrovic et al.]; and
U.S. Pat. No. 6,433,121 [Petrovic et al.].
   Alternatively, the epoxidation reaction may be conducted under conditions that result in a polyol having residual double bonds.

Also suitable are modified vegetable-oil based polyols prepared by a hydroformylation process. In this process, a vegetable oil is reacted with carbon monoxide and hydrogen in the presence of a Group VIII metal catalyst (e.g., a rhodium catalyst) to form a hydroformylated vegetable oil. The hydroformylated vegetable oil is then hydrogenated to form the modified vegetable oil-based polyol. This process produces polyols containing all primary hydroxyl groups. These polyols may be used directly in a reaction mixture to produce an isocyanate-based foam such as a polyurethane foam. Alternatively, they may be reacted with the epoxidized vegetable oils described above in the presence of a fluoroboric acid catalyst and, optionally, water to form a polyol suitable for use in a reaction mixture to produce an isocyanate-based foam such as a polyurethane foam.

A preferred bio-based polyol is described in International Publication Number WO 2008/106769 [Stanciu et al.].

In the foamable composition used to produce the present isocyanate-based polymer foam, a catalyst is usually incorporated in the reaction mixture. The catalyst used in the reaction mixture is a compound capable of catalyzing the polymerization reaction and the blowing (foaming) reaction. Such catalysts are known, and the choice and concentration thereof in the reaction mixture is within the pure view of a person skilled in the art. See, for example, U.S. Pat. Nos. 4,296,213 and 4,518,778 for a discussion of suitable catalyst compounds. Non-limiting examples of suitable catalysts include tertiary amines and/or organometallic compounds. Additionally, as is known in the art, when the objective is to produce an isocyanurate, a Lewis acid must be used as the catalyst, either alone or in conjunction with other catalysts. Of course it will be understood by those skilled in the art that a combination of two or more catalysts may be suitably used.

The reaction mixture used to produce the polyurethane foam typically will further comprise a blowing agent. As is known in the art, water can be used as an indirect or reactive blowing agent in the production of foamed isocyanate-based polymers. Specifically, water reacts with the isocyanate forming carbon dioxide which acts as the effective blowing agent in the final foamed polymer product. Alternatively, the carbon dioxide may be produced by other means such as unstable compounds which yield carbon dioxide (e.g., carbamates and the like). The preferred blowing agent for use in the production of the present foamed isocyanate-based polymer comprises water.

It is known in the art that the amount of water used as an indirect blowing agent in the preparation of a foamed isocyanate-based polymer (e.g., polyurethane) is conventionally in the range of from about 0.5 to as high as about 40 or more parts by weight, preferably from about 1.0 to about 10 parts by weight, based on 100 parts by weight of the total active hydrogen-containing compound content in the reaction mixture. As is known in the art, the amount of water used in the production of a foamed isocyanate-based polymer typically is limited by the fixed properties expected in the foamed polymer and by the tolerance of the expanding foam towards self structure formation, flame retardance and the like.

Embodiments of the present invention will now be described with reference to the following Examples which should not be construed as limiting the scope of the invention.

In the Examples the compounds set out in Table 1 were used to produce various isocyanate-based polymer foams. Except for water, all compounds are commercially available from Xanathane Systems.

The various isocyanate-based polymer foams were produced using the Variable Ratio Plural Component Spray Equipment obtained from Bolair Fluid Handling Systems. This variable ratio system was manufactured by Glass-Craft Indianapolis, Ind., is was configured to supply a variety of gravimetric isocyanate/resin (i.e., all remaining ingredients combined) in ratios between 1-0.50 on both sides of the supply lines.

The spray equipment had an independent primary heater for both isocyanate and resin. The isocyanate and resin were supplied to high pressure heated hose lines.

The spray equipment has two supply lines, line B having a Graco diaphragm transfer pump for the resin, and line A having also a diaphragm transfer pump for isocyanate used in the examples.

FUSION AP Air-Purge Gun having a maximum working pressure of 3,500 psi and maximum fluid temperature of 93° C. was used to mix the feeds from line A and line B.

The working settings on spray equipment were:

pressure on line A—1,200 psi;

pressure on line B—1,200 psi;

temperature on line A—58° C.; and

temperature on line B—58° C.

The feeds from line A and line B were mixed in a 1:1 volumetric ratio and dispensed in a wood box having the dimensions 130 cm×50 cm×13 cm to obtain foam buns for testing. In addition, the feeds from line A and line B were mixed and spray on to a metal sheet having the dimensions 130 cm×50 cm×0.3 cm having temperatures between −20° C. and 25° C. to assess adhesion of the foam to the surface of the metal sheet (to mimic application to the framework of a vehicle such as a bus). The reactivity profile of the system was performed measuring Cream Time (sec), Gel Time (sec), Rise Time (sec) and Tack Free Time (sec).

The foam samples were subjected to Total Volatile Organic Carbon (TVOC) content analysis were using the procedure set out in VDA-277 standard “Determination of Organic Emission of Non-metallic materials from vehicles Interior”. The VDA-277 test method measures the emission potential of a material, the sum of all release values of the emitted substances using a gas chromatograph and detection with a Flame ionization detector. The test operates by means of steam space analysis (Head Space technology) at a temperature of 120° C. The sample size for TVOC testing purposes was 10 to 25 g.

The foam samples were also subjected to Limiting Oxygen Index (LOI) tests performed in accordance with ASTM D-2863 and JT/T-1905-2016 standards. The Limiting Oxygen Index (LOI) test is a fire test response procedure which is widely used in research and quality control for determining the relative flammability of polymeric materials. A numerical index, the LOI is defined as the minimum concentration of oxygen in an oxygen-nitrogen mixture, required to just support downward burning of a vertically mounted test specimen. Hence, higher LOI values represent better flame retardancy. The LOI test method is generally reproducible to an accuracy of +0.5%. Although originally designed for testing of plastics, the method has been used extensively for evaluating the relative flammability of rubbers, textiles, paper, coatings and other materials. The sample size for LOI testing purposes was used was 0.25 inch×0.25 inch×6 inches.

### Example 1—Comparative

In this Example, foam samples were produced using the above methodology from spray foam formulations commercially available from Xanathane Systems. Accordingly, Example 1 is comparative only and the foams produced therein do not fall within the scope of the invention.

Table 2 sets out the formulations used and some of the properties of the resulting foams.

The higher density V2D spray foam had a desirable LOI but the TVOC was unacceptably high. The use of auxiliary hydrocarbon-based blowing agents (Forane 365mfc) will dramatically increase the TVOC value as seen in the V2D spray foam.

Density of the foam is an important property. The lower density V-300 spray foam, despite its high loading with FR (flame retardant) was able to achieve an LOI of only 23.0%. The TVOC of this foam was also unacceptably high.

The V-100 spray foam was the only one with and acceptable TVOC. However, the LOI for this spray foam was unacceptably low.

The results of this Example demonstrate that certain commercially available spray foam formulations did not produced isocyanate-based polymer foam having the combination of: (i) a Limiting Oxygen Index (LOI) of greater than or equal to 26.5% when measured pursuant to ASTM D2863-17a, and (ii) a Total Volatile Organic Content (TVOC) when measured pursuant to VDA 277 of less than or equal to 225 μg/g C.

### Examples 2-4—Comparative

In these Examples, the intent was to produce foam samples that had improved flammability properties (i.e., higher LOI) than the V-100 spray foam sample made in Example will maintain the TVOC of that foam sample. Specifically, the FR (flame retardant) loading was increased and the amount of water was reduced.

The foam samples were produced using the above methodology from ingredients commercially available from Xanathane Systems. The ingredients used in these Examples are set out in Tables 3-5 where all parts are parts by weight (unless otherwise indicated).

As will be apparent, the formulations in Tables 3-5 contained relatively high amounts of so-called conventional polyether polyols. Those polyether polyols do not fall within the definition of “reactive compound” used in this specification (i.e., they do contain (1) at least one hydrogen which is reactive with the isocyanate, and (2) one or both of a halogen and a phosphate moiety). The only such ingredient in Table 2 is XB2000. Accordingly, Examples 2-4 are comparative only and the foams produced therein do not fall within the scope of the invention.

Tables 3-5 also forth some of the properties of the resulting foams. As is apparent, increasing the FR loading lead to a desirable increase in LOI but, unfortunately, the density of each increased as did the TVOC to unacceptable levels (i.e., well above 225 μg/g C).

### Examples 5-8—Invention

In these Examples, the intent was to produce foam samples that had improved flammability properties (i.e., LOI equal to or greater than 26.5%) and improved TVOC properties (i.e., TVOC less than or equal to 225 μg/g C) compared to the foam samples produced in Examples 1-4. Specifically, the polyether polyols conventionally used to produce polyurethane foams were omitted and the amount of the “reactive compound” (as defined in this specification: a compound that has (1) at least one hydrogen which is reactive with the isocyanate, and (2) one or both of a halogen and a phosphate moiety) XB2000 was increased

The foam samples were produced using the above methodology from ingredients commercially available from Xanathane Systems. The ingredients used in these Examples are set out in Tables 6-8 where all parts are parts by weight (unless otherwise indicated).

Tables 6-8 also forth some of the properties of the resulting foams. As is apparent, the shift away from polyether polyols conventionally used to produce polyurethane foams to a significant amount of the “reactive compound” (as defined in this specification: a compound that has (1) at least one hydrogen which is reactive with the isocyanate, and (2) one or both of a halogen and a phosphate moiety) XB2000 resulting in a very desirable combination of LOI and TVOC. Specifically, each foam sample had (i) a Limiting Oxygen Index (LOI) of greater than or equal to 26.5% when measured pursuant to ASTM D2863-17a, and (ii) a Total Volatile Organic Content (TVOC) when measured pursuant to VDA 277 of less than or equal to 225 μg/g C.

### Examples 9-10—Invention

In these Examples, the intent was to produce foam samples that had improved flammability properties (i.e., LOI equal to or greater than 26.5%) and improved TVOC properties (i.e., TVOC less than or equal to 225 μg/g C) compared to the foam samples produced in Examples 1-4. Specifically, the polyether polyols conventionally used to produce polyurethane foams were omitted and the amount of the “reactive compound” (as defined in this specification: a compound that has (1) at least one hydrogen which is reactive with the isocyanate, and (2) one or both of a halogen and a phosphate moiety) XB2000 was increased. These Examples represent the most preferred embodiments of the invention currently contemplated by the inventors.

The foam samples were produced using the above methodology from ingredients commercially available from Xanathane Systems. The ingredients used in these Examples are set out in Tables 9-10 where all parts are parts by weight.

Tables 9-10 also forth some of the properties of the resulting foams. As is apparent, the shift away from polyether polyols conventionally used to produce polyurethane foams to a significant amount of the “reactive compound” (as defined in this specification: a compound that has (1) at least one hydrogen which is reactive with the isocyanate, and (2) one or both of a halogen and a phosphate moiety) XB2000 resulting in a very desirable combination of LOI and TVOC. Specifically, each foam sample had (i) a Limiting Oxygen Index (LOI) of greater than or equal to 26.5% when measured pursuant to ASTM D2863-17a, and (ii) a Total Volatile Organic Content (TVOC) when measured pursuant to VDA 277 of less than or equal to 225 μg/g C.

While this invention has been described with reference to illustrative embodiments and examples, the description is not intended to be construed in a limiting sense. Thus, various modifications of the illustrative embodiments, as well as other embodiments of the invention, will be apparent to persons skilled in the art upon reference to this description. It is therefore contemplated that the appended claims will cover any such modifications or embodiments.

All publications, patents and patent applications referred to herein are incorporated by reference in their entirety to the same extent as if each individual publication, patent or patent application was specifically and individually indicated to be incorporated by reference in its entirety.

TABLE 1

| Ingredient | Commercial Name |
|---|---|
| Polyether polyol | XB0251 |
| Polyether polyol | XB0281 |
| Cell Opener | XB0250 |
| Reactive Compound | XB2000 |
| Flame Retardant | XB2001 |
| Flame Retardant | XB2002 |
| Crosslinker | XB0273 |
| Emulsifier | XB0391 |
| Emulsifier | XB0390 |
| Water | n/a |
| Cell Stabilizer | XS0290 |
| Gel Catalyst | XC0269 |
| Blow Catalyst | XC0270 |
| Gel Catalyst | XC0271 |
| Gel Catalyst | XC0272 |
| Isocyanate* | XM0010 |

*Used in Examples 2-10

TABLE 2

Commerially Available Formulation
(Xanathane Systems)

| Property | V-100¹ | V-300² | V2D³ |
|---|---|---|---|
| Forane 365mfc (%**) | — | — | 25 |
| XB2000 (%**) | 14.5 | — | — |
| Water (%**) | 15 | 28.5 | — |
| Isocyanate Index | 50 | 29 | 331 |
| Density (kg/m³) | 8.84 | 7.24 | 29.1 |
| FR loading (%) | 24.5 | 43.5 | 24.0 |
| TVOC (μg/g C) | ~100 | 433 | 37,189 |
| LOI (%) | 21.7 | 23.0 | 30.0 |

¹nsulatus I0.5-V100
²Insulatus I0.5-V300
³Insulatus I0.5-V2D
**percent by weight per 100 parts by weight of resin (all ingredients except isocyanate)

TABLE 3

| Component | Amount | % Iso Equivalents⁴ |
|---|---|---|
| XB0251 | 28.00 | 7.74 |
| XB0281 | 11.00 | 38.46 |
| XS0290 | 1.00 | 0 |
| Water | 7.5 | 0 |
| XB2000 | 12.00 | 19.89 |
| XB2001 | 28.00 | 0 |
| XB0273 | 3.00 | 9.04 |
| XC0269 | 5.00 | 24.88 |

| | |
|---|---|
| Core Density (kg/m³) | 18.1 |
| LOI (%) | 26.4 |
| TVOC (μg/g C) | 346 |

⁴Excluding water

TABLE 4

| Component | Amount | % Iso Equivalents⁵ |
|---|---|---|
| XB0251 | 28.00 | 7.60 |
| XB0281 | 11.50 | 39.52 |
| XS0290 | 0.50 | 0 |
| Water | 7.5 | 0 |
| XB2000 | 12.00 | 19.55 |
| XB2001 | 28.00 | 0 |
| XB0273 | 3.00 | 8.88 |
| XC0269 | 5.00 | 24.45 |

| | |
|---|---|
| Core Density (kg/m³) | 17.7 |
| LOI (%) | 26.3 |
| TVOC (μg/g C) | 358 |

⁵Excluding water

TABLE 5

| Component | Amount | % Iso Equivalents⁶ |
|---|---|---|
| XB0251 | 25.00 | 6.94 |
| XB0282 | 11.00 | 38.65 |
| XS0290 | 1.50 | 0 |
| Water | 10.00 | 0 |
| XB2000 | 12.20 | 20.32 |
| XB2001 | 27.90 | 0 |
| XB0273 | 3.00 | 9.08 |
| XC0269 | 5.00 | 25.00 |

| | |
|---|---|
| Core Density (kg/m³) | 13.4 |
| LOI (%) | 26.1 |
| TVOC (μg/g C) | 409 |

⁶Excluding water

TABLE 6

| Component | Amount | % Iso Equivalents⁷ |
|---|---|---|
| XB2000 | 54.90 | 78.05 |
| XB2002 | 0 | 0 |
| XB2001 | 30.00 | 0 |
| XS0290 | 0.40 | 0 |
| XB0273 | 3.0 | 7.78 |
| XC0269 | 3.0 | 12.79 |
| Water | 4.5 | 0 |

| | |
|---|---|
| Core Density (kg/m³) | 26.2 |
| LOI (%) | 29.1 |
| TVOC (μg/g C) | 225 |

⁷Excluding water

TABLE 7

| Component | Amount | % Iso Equivalents⁸ |
|---|---|---|
| XB2000 | 55.40 | 81.67 |
| XB2002 | 31.00 | 0 |
| XB2001 | 0 | 0 |
| XS0290 | 0 | 0 |
| XB0273 | 3.0 | 8.06 |
| XC0269 | 2.0 | 8.84 |
| Water | 4.5 | 0 |

| | |
|---|---|
| Core Density (kg/m³) | 29.2 |
| LOI (%) | 28.0 |
| TVOC (μg/g C) | 80 |

⁸Excluding water

TABLE 8

| Component | Amount | % Iso Equivalents⁹ |
|---|---|---|
| XB2000 | 31.00 | 71.39 |
| XB2002 | 55.40 | 0 |
| XB2001 | 0 | 0 |
| XS0290 | 0 | 0 |
| XB0273 | 3.0 | 12.58 |
| XC0269 | 2.0 | 13.79 |
| Water | 4.5 | 0 |

| | |
|---|---|
| Core Density (kg/m³) | 26.4 |
| LOI (%) | 30.0 |
| TVOC (μg/g C) | 105 |

⁹Excluding water

TABLE 9

| Component | Amount | % Iso Equivalents⁹ |
|---|---|---|
| XB2000 | 48.40 | 79.18 |
| XB2002 | 35.00 | 0 |
| XB0250 | 3.00 | 0.47 |
| XB0273 | 3.00 | 8.95 |
| XC0269 | 2.00 | 9.81 |
| Water | 4.5 | 0 |

| | |
|---|---|
| Core Density (kg/m³) | 25.4 |
| LOI (%) | 28.0 |
| TVOC (μg/g C) | 130 |

⁹Excluding water

TABLE 10

| Component | Amount | % Iso Equivalents¹⁰ |
|---|---|---|
| XB2000 | 30.00 | 70.24 |
| XB2002 | 53.40 | 0 |
| XB0250 | 3.00 | 0.67 |
| XB0273 | 3.00 | 12.79 |
| XC0269 | 2.00 | 14.03 |
| Water | 4.5 | 0 |

| | |
|---|---|
| Core Density (kg/m³) | 26.7 |
| LOI (%) | 27.5 |
| TVOC (μg/g C) | 71.0 |

¹⁰Excluding water

What is claimed is:

1. An isocyanate-based polymer foam having the combination of: (i) a Limiting Oxygen Index (LOI) of greater than or equal to 26.5% when measured pursuant to ASTM D2863-17a, and (ii) a Total Volatile Organic Content (TVOC) when measured pursuant to VDA 277 of less than or equal to 225 μg/g C.

2. The isocyanate-based polymer foam defined in claim 1, having a LOI in the range of from 26.5% to 35.0%.

3. (canceled)

4. The isocyanate-based polymer foam defined in claim 1, having a LOI in the range of from 27.0% to 34.0%.

5. (canceled)

6. The isocyanate-based polymer foam defined in claim 1, having a LOI in the range of from 27.0% to 32.0%.

7. (canceled)

8. The isocyanate-based polymer foam defined in claim 1, having a LOI in the range of from 27.0% to 31.0%.

9. (canceled)

10. The isocyanate-based polymer foam defined in claim 1, having a LOI in the range of from 27.5% to 30.0%.

11. The isocyanate-based polymer foam defined in claim 1, having a LOI in the range of from 28.0% to 30.0%.

12. The isocyanate-based polymer foam defined in claim 1, having a TVOC in the range of from 50 to 225 μg/g C.

13. The isocyanate-based polymer foam defined in claim 1, having a TVOC in the range of from 50 to 215 μg/g C.

14. (canceled)

15. The isocyanate-based polymer foam defined in claim 1, having a TVOC in the range of from 50 to 170 μg/g C.

16. (canceled)

17. The isocyanate-based polymer foam defined in claim 1, having a TVOC in the range of from 60 to 150 μg/g C.

18. (canceled)

19. The isocyanate-based polymer foam defined in claim 1, having a TVOC in the range of from 70 to 140 μg/g C.

20. The isocyanate-based polymer foam defined in claim 1, having a TVOC in the range of from 70 to 130 μg/g C.

21. (canceled)

22. The isocyanate-based polymer foam defined in claim 1, having a TVOC in the range of from 70 to 110 μg/g C.

23. The isocyanate-based polymer foam defined in claim 1, having a TVOC in the range of from 70 to 100 μg/g C.

24. The isocyanate-based polymer foam defined in claim 1, produced from a foamable composition comprising:
(a) an isocyanate;
(b) a reactive compound containing: (1) at least one hydrogen which is reactive with the isocyanate, and (2) one or both of a halogen and a phosphate moiety;
(c) a blowing agent comprising one or both of water and carbon dioxide; and
(d) a catalyst;
wherein the reactive compound is present in an amount in the range of from about 30% to about 95% of total ISO equivalents excluding water, if present in the foamable composition.

25. An isocyanate-based polymer foam produced from a foamable composition comprising:
(a) an isocyanate;
(b) a reactive compound containing: (1) at least one hydrogen which is reactive with the isocyanate, and (2) one or both of a halogen and a phosphate moiety;
(c) a blowing agent comprising one or both of water and carbon dioxide; and
(d) a catalyst;
wherein the reactive compound is present in an amount in the range of from about 30% to about 95% of total ISO equivalents excluding water, if present in the foamable composition.

26. The isocyanate-based polymer foam defined in claim 24, wherein the reactive compound is present in an amount in the range of from about 40% to about 90% of total ISO equivalents excluding water.

27. (canceled)

28. The isocyanate-based polymer foam defined in claim 24, wherein the reactive compound contains one or more of the following moieties: hydroxyl (R—OH), amino (R—NH₂) and iminyl (R═NH).

29. (canceled)

30. The isocyanate-based polymer foam defined in claim 24, wherein the foamable composition is substantially completely free of a polyol comprising a hydroxyl-terminated backbone of a member selected from the group consisting of polyether, polyester, polycarbonate, polydiene and polycaprolactone.

31. (canceled)

32. (canceled)

33. (canceled)

34. (canceled)

35. (canceled)

36. (canceled)

37. (canceled)

38. (canceled)

39. (canceled)

40. (canceled)

41. (canceled)

42. (canceled)

43. (canceled)
